(19) United States
(12) Patent Application Publication
(10) Pub. No.: US 2010/0332403 A1
(43) Pub. Date: Dec. 30, 2010

(54) METHOD AND APPARATUS FOR TRACKING CUSTOMER TRANSACTIONS USING A UNIQUE LOYALTY CODE

(75) Inventors: Robert Charles Angell, West Greenwich, RI (US); James R. Lavoie, Voluntown, CT (US)

Correspondence Address: RYAN, MASON & LEWIS, LLP, 1300 POST ROAD, SUITE 205, FAIRFIELD, CT, 06824, US

(73) Assignee: Rite-Solutions, Inc., Pawcatuck, CT (US)

(21) Appl. No.: 12/828,598

(22) Filed: Jul. 1, 2010

Related U.S. Application Data
(63) Continuation-in-part of application No. 10/557,245, filed on Oct. 30, 2006.
(60) Provisional application No. 61/222,703, filed on Jul. 2, 2009.
(60) Provisional application No. 60/471,150, filed on May 16, 2003.

(51) Int. Cl. G06Q 30/00; G06Q 90/00; G06Q 99/00

(52) U.S. Cl. 705/308; 705/500; 705/1.1

(57) ABSTRACT

Methods and apparatus are provided for tracking customer transactions using a Unique Loyalty Code. One or more transactions of a user are monitored by providing a unique loyalty code with a sale of a product, wherein the unique loyalty code uniquely identifies each individual instance of the product. The unique loyalty code is then received from the user as part of a product registration process, wherein the product registration process does not require personal information of the user. The unique loyalty code is recorded in an account anonymously associated with the user. The disclosed unique loyalty codes can be used to monitor the recycling of products.

### CROSS REFERENCE TO RELATED APPLICATIONS

This application claims priority to U.S. Provisional Application No. 61/222,703, filed Jul. 2, 2010 and is a continuation-in-part application of U.S. patent application Ser. No. 10/557,245, filed Oct. 30, 2006, which claims priority to PCT Application Number PCT/US04/14902 and U.S. Provisional Application No. 60/471,150, filed May 16, 2003, each incorporated by reference herein.

### FIELD OF THE INVENTION

The present invention relates generally to loyalty reward programs, and more particularly, to methods and apparatus for tracking customer behavior using a unique anonymous identifier.

### BACKGROUND OF THE INVENTION

In order to attract new customers and to strengthen customer loyalty among existing customers, many businesses offer loyalty reward programs. Loyalty reward programs are commonplace in a wide variety of industries, including travel and grocery stores. Each member in a loyalty reward program is generally issued a membership card having an identification number, after a registration process that collects certain personal information, such as a name, address and additional demographic information. The business thereafter credits the customer with loyalty points (or airline miles) for each purchase. Typically, accumulated loyalty points can be redeemed for goods, services or discounts on future purchases. The loyalty reward programs provide a mechanism for companies to monitor the purchase history of each enrolled customer, and to thereby ascertain behavioral trends. In addition, the business can review the recorded activity and award a corresponding level of reward to each customer.

While such loyalty reward programs often successfully develop customer loyalty, it has been found that many customers are uncomfortable providing personal information and are distrustful of the motives of the business for gathering data regarding their activities. The collection of personal information is particularly sensitive (and may be unlawful) in the case of minors.

Further, the level of discomfort may vary with the nature of the products or services offered by the business. For example, a customer may be particularly unwilling to reveal their personal information in connection with purchases of lottery tickets or liquor. For this reason, participation in these programs, while significant, is limited to a particular demographic that is willing to have their purchase history monitored. Meanwhile, traditional methods of collecting consumer information without direct consumer cooperation may provide useful information but only with coarse resolution and no ability to directly and visibly benefit consumers.

### SUMMARY OF THE INVENTION

Generally, methods and apparatus are provided for tracking customer transactions using a Unique Loyalty Code. According to one aspect of the invention, one or more transactions of a user are monitored by providing a unique loyalty code with a sale of a product, wherein the unique loyalty code uniquely identifies each individual instance of the product. The unique loyalty code is then received from the user as part of a product registration process, wherein the product registration process does not require personal information of the user. The unique loyalty code is recorded in an account anonymously associated with the user.

According to further aspects of the invention, the unique loyalty code can optionally be associated with one or more prior transactions of the user. The unique loyalty code is recorded in an existing account of the user (if available), that is identified using an account identifier that is not linked to the personal information of the user. The method unique loyalty code can be provided to the user, for example, as part of packaging associated with the product or electronically to the user. The user can optionally elect to update the account with personal information. The unique loyalty codes of the present invention allow the transactions of the user to be tracked. In this manner, the user may become eligible for one or more loyalty rewards.

According to another aspect of the invention, the unique loyalty codes can be used to track the recycling efforts of the user. For example, the unique loyalty code can be presented by the user to a recycling system at the time the product is recycled. In this manner, the participation of the user in recycling programs is encouraged. The disclosed anonymous loyalty tracking system encourages recycling and participation by combining the recycling program with a loyalty program incorporating aspects of the present invention.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is an exemplary receipt having a purchase identifier that can be used as a unique anonymous identifier to provide anonymous tracking of consumer purchases in accordance with the present invention;

FIG. 3 is an exemplary lottery receipt having a purchase identifier that can be used as a unique anonymous identifier to provide anonymous tracking of consumer purchases in accordance with the present invention;

FIG. 4 is a sample record associated with the receipt of FIG. 2 from a transaction database;

FIG. 5 is a sample record associated with the lottery receipt of FIG. 3 from a transaction database;

FIG. 6 is a flow chart describing an exemplary implementation of an anonymous consumer tracking process as employed by the transaction server of FIG. 1;

FIG. 7 is a schematic block diagram of one embodiment of the transaction server of FIG. 1 in further detail incorporating features of the present invention;

FIG. 8 is a flow chart describing an exemplary implementation of an anonymous loyalty tracking process incorporating features of the present invention;

FIG. 9 is a flow chart describing an exemplary implementation of a loyalty profile update process incorporating features of the present invention; and

FIG. 10 is a schematic block diagram of a loyal recycling system in which the present invention can operate.

### DETAILED DESCRIPTION

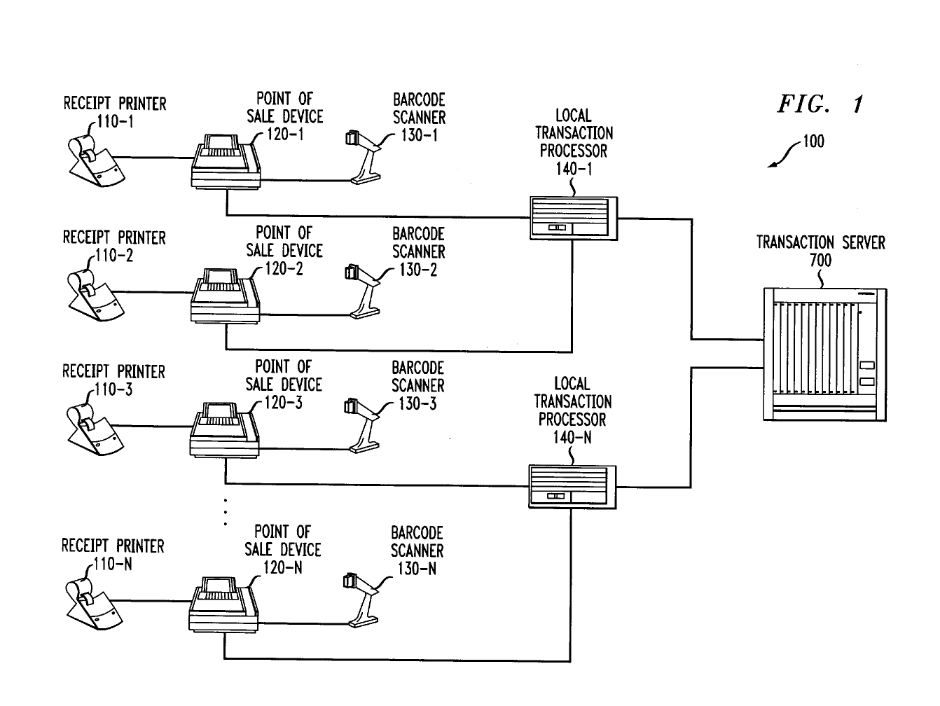

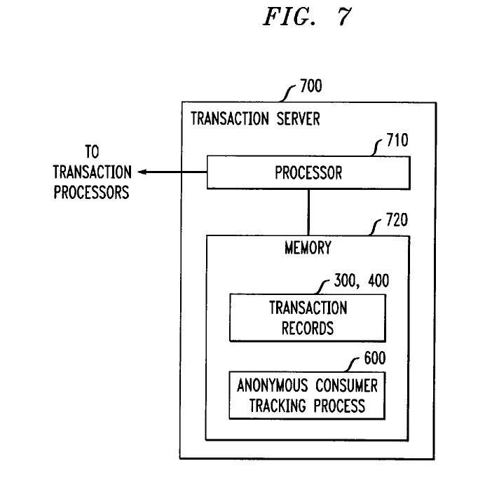

FIG. 1 illustrates a network environment 100 in which the present invention can operate. The network environment 100 may be, for example, a network provided by a retailer, retail associated, or credit card processing company to link computing devices in a distributed retail environment. The network environment 100 may be embodied as a public or private network (or both) permitting wired or wireless connections (or both) between computing devices. As shown in FIG. 1, the exemplary network environment 100 includes one or more point of sale devices 120-1 through 120-N, each having an associated receipt printer 110-1 through 110-N and bar code scanner 130-1 through 130-N. One or more of the point of sale devices 120 can be connected to a corresponding local transaction processor 140-1 through 140-N. For example, a local transaction processor 140 may be provided for each individual retail store. Each of the local transaction processors 140 are connected to a centralized transaction server 700, discussed further below in conjunction with FIG. 7.

According to one aspect of the present invention, a business can anonymously monitor the purchases or other transactions of customers while directly rewarding consumers for such purchases. The anonymous rating and tracking of consumers eliminates most consumer objections to conventional tracking and rating systems. The present invention does not require a customer to enroll or to establish an account, nor to produce proof of membership when making a purchase. In addition, the customer does not have to be identified to the business. Nonetheless, the actions of the customer can be tracked by the business as an individual, and rewards can be earned and presented directly to that individual. In this manner, the business can acquire high-resolution information, while allowing the customer to remain anonymous. Furthermore, the business can reward desirable behavior, which provides a direct benefit to the customer.

Anonymous rating and tracking is accomplished in accordance with the present invention by recording behavior (business transactions) against an account. All actions carried out against a given account are attributed to an individual. Unlike conventional solutions, however, the anonymous solution of the present invention creates accounts dynamically when a business transaction is conducted. In one exemplary embodiment, customers simply present a receipt from a prior transaction or some other consistent token when conducting the current transaction and the new activity is associated with the prior account. In this manner, a link is created among the various transactions associated with a given, anonymous consumer. New accounts are created when prior accounts are not referenced.

According to a further aspect of the invention, accumulated rewards can be presented to the consumer when business is conducted. For example, reward status can be made available to the consumer by presenting the token of a prior transaction to an information kiosk, or via a computer network (such as the Internet), or to service personnel designated to assist consumers. The presentation of the token of a prior transaction is sufficient to link the current activity to that from the past and hence the behavior of the individual can be tracked. Since the individual can present such a token at any time, the rewards associated with the consumer's history can be granted at any time, with nothing more required than any past proof of a business transaction.

The anonymous rating and tracking of the present invention does not provide the business with demographic information for a particular individual. Such information would be useful, for example, to contact the individual (for direct promotions and the like) and also to make generalizations about consumer performance based on demographic factors such as age, sex, and home geographic area. Nonetheless, since the anonymous data is being gathered for individuals who prefer to remain anonymous, no demographic data would have been otherwise available, and in fact, no performance data would be available as well. Furthermore, each time a customer visits a participating business, a new opportunity exists to provide promotions and rewards to the customer, without disturbing the customer's sense of privacy.

In addition, the consumer may lose some of the intimacy of the experience with the business, such as the business being unable to greet the customer by name, or rewards may not be delivered to the customer's home. If a customer desires a level of intimacy that cannot be provided in an anonymous relationship, then the customer is free to provide additional personal details at any point, such as name and address information. Providing this additional detail only enhances the amount of information stored with the account but does not change the other functionality (such as linking with any previous purchases). The anonymous method of the present invention is envisioned as a complement or supplement to, rather than a replacement for, conventional tracking and rating systems.

Furthermore, if the anonymous method of the present invention is joined with a traditional tracking and rating system, the lack of demographic information for customers in the anonymous system can be overcome by identifying correlations between customers in the anonymous tracking system and the personalized tracking system. For example, statistical methods exist that facilitate the clustering of performance information for the purpose of identification or projection of future activity by nodes in a system (accounts that are being tracked). Recent advances in computing technology make this method tractable as computers can easily manage the very large data sets involved, and computational methods have evolved to make effective use of them and allow the effective and accurate correlation of such data and to draw meaningful conclusions from them.

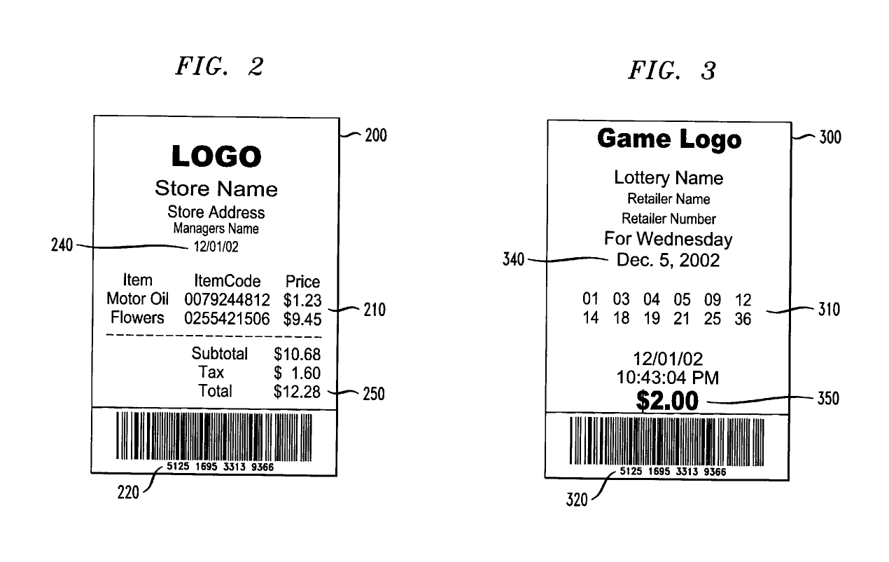

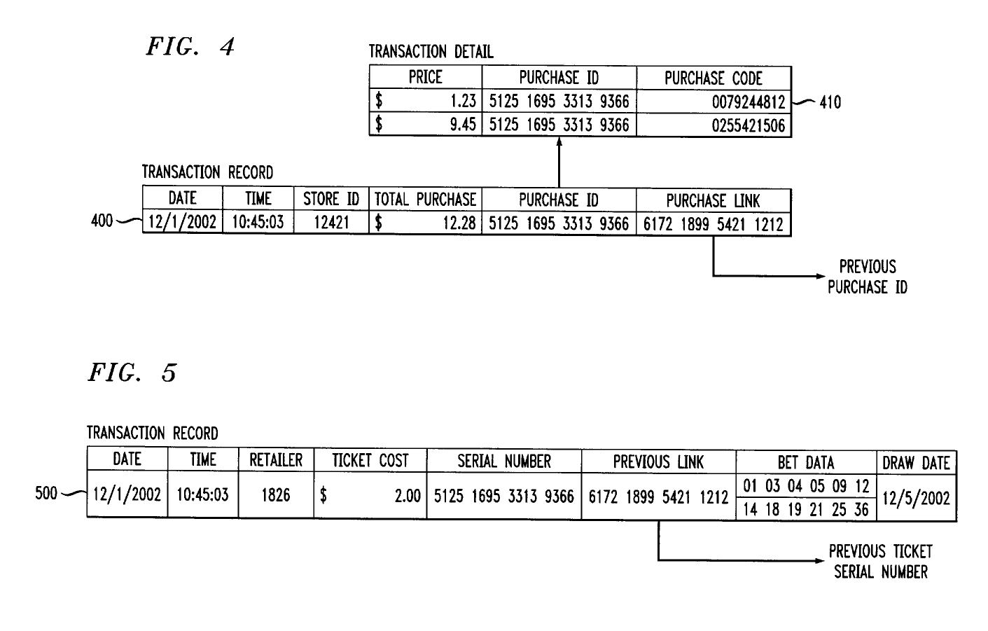

FIG. 2 illustrates an exemplary receipt 200 having a purchase identifier 220 that can be used as a unique anonymous identifier to provide anonymous tracking of consumer purchases in accordance with the present invention. As shown in FIG. 2, the exemplary receipt 200 includes an area 210 for itemizing the various items purchased by the customer. The purchase identifier 220 provides a unique number that identifies the transaction and may be utilized as a key into a transaction database 300, 400, as discussed further below in conjunction with FIGS. 3 and 4, that stores information on each transaction. In addition, the purchase identifier 220 provides a unique number that is used in accordance with the present invention to provide a mechanism for linking all of the transactions associated with a given customer. The date of the transaction is indicated on the receipt 200 in a date field 240 and the total amount of the purchase is indicated in an amount field 250. The manner in which the various parameters of the transaction are recorded in a corresponding record 400 in a transaction database is discussed below in conjunction with FIG. 4.

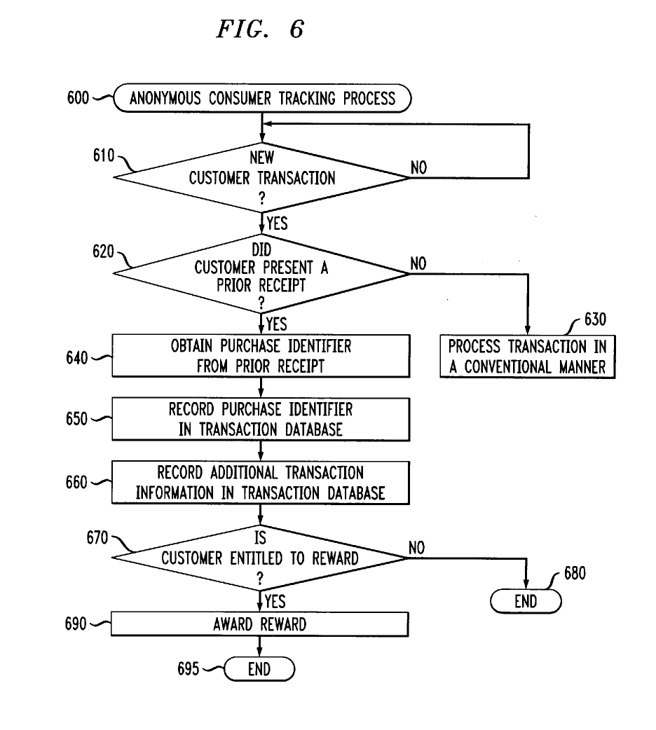

FIG. 3 is an exemplary lottery receipt 300 having a purchase identifier 320 that can be used as a unique anonymous identifier to provide anonymous tracking of consumer purchases in accordance with the present invention. As shown in FIG. 3, the exemplary lottery receipt 300 includes an area 310 for itemizing the various numbers selected by (or for) the customer for a given lottery game. The purchase identifier 320 provides a unique number that identifies the transaction and may be utilized as a key into a transaction database 300, 400, as discussed further below in conjunction with FIGS. 3 and 4, that stores information on each transaction. In addition, the purchase identifier 320 provides a unique number that is used in accordance with the present invention to provide a mechanism for linking all of the transactions associated with a given customer. The draw date of the lottery game is indicated on the lottery receipt 300 in a draw date field 340 and the total amount of the wager is indicated in an amount field 350. The manner in which the various parameters of the transaction are recorded in a corresponding record 500 in a transaction database is discussed below in conjunction with FIG. 5.

FIG. 4 is a sample record 400 associated with the receipt 200 of FIG. 2 from a transaction database. The transaction database typically includes a record associated with each transaction. As shown in FIG. 4, the exemplary transaction record 400 includes a plurality of fields for recording the date, time, store, purchase amount, purchase identifier and purchase link (to a previous transaction) of a given transaction. Generally, the fields of the exemplary transaction record 400 are populated with information from the corresponding receipt 200 of FIG. 2. In accordance with the present invention, the purchase identifier uniquely identifies the current transaction and can be presented in connection with a future transaction to link the purchases of the current customer. In this sense, the present invention provides added value to a piece of paper (i.e., the receipt 200) that ordinarily would have little or no value. In addition, the current exemplary transaction is linked to a previous transaction associated with the same customer through the purchase link to a previous transaction. In other words, when the customer made the present purchase of motor oil and flowers, as indicated in the transaction detail 310, the customer presented a receipt from a prior purchase having the purchase identifier that is recorded in the purchase link field. It is noted that upon a future purchase, the same customer can present any previously linked receipt in order to link the future purchase to the previously linked purchases, as would be apparent to a person of ordinary skill in the art.

FIG. 5 is a sample record 500 associated with the lottery receipt 300 of FIG. 3 from a transaction database. As shown in FIG. 5, the exemplary transaction record 500 includes a plurality of fields for recording the date, time, store (retailer), purchase amount (ticket cost), purchase identifier (serial number) and purchase link (to a previous transaction) of a given transaction. In addition, the lottery receipt 300 typically identifies the various numbers selected by (or for) the customer for a given lottery game, as well as the corresponding draw date. The lottery receipt 300 provides evidence of a game play and is typically required to redeem a winning ticket. Once the game is played, however, losing tickets typically have no value. Thus, as previously indicated, the present invention provides added value to a piece of paper (i.e., the losing lottery receipt 300) that ordinarily would have little or no value. Generally, the fields of the exemplary transaction record 500 are populated with information from the corresponding lottery receipt 300 of FIG. 3. In accordance with the present invention, the purchase identifier (serial number) uniquely identifies the current transaction and can be presented in connection with a future transaction to link the purchases of the customer. It is noted that in connection with the purchase of the lottery ticket 300, the customer presented the same previous receipt associated with a previous purchase as was presented with the receipt 200 in order to link the transactions. Thus, both records 400, 500 have the same purchase/previous link to a prior transaction.

According to a further aspect of the present invention, the receipts 200, 300 presented to a customer in connection with a transaction can be identical to a conventional receipt. Thus, modifications are not required to the point of sale device 120 or the receipt printer 110. The only modification to a conventional transaction processing system is the ability to obtain a receipt associated with a prior purchase, and to extract the purchase identifier from the prior receipt, for example, using the bar code scanner 130, for recording in a corresponding record 300, 400, of the transaction database. Likewise, the transaction database may be embodied as a conventional transaction database, as modified herein to include an additional field for recording the purchase identifier from the prior receipt as a purchase link for the present transaction.

FIG. 6 is a flow chart describing an exemplary implementation of an anonymous consumer tracking process 600 as employed by the transaction server 700 of FIGS. 1 and 7. As shown in FIG. 6, the exemplary anonymous consumer tracking process 600 is initiated during step 610 when a new customer transaction is detected. A test is performed during step 620 to determine if the customer presented a prior receipt in connection with the new customer transaction. If it is determined during step 620 that the customer did not present a prior receipt in connection with the new customer transaction, then to process is handled in a conventional manner during step 630.

If, however, it is determined during step 620 that the customer presented a prior receipt in connection with the new customer transaction, then the purchase identifier is obtained from the prior receipt during step 640 and recorded in the purchase link field of a record created in the transaction database for the current transaction during step 650. Additional transaction information, such as date, time and amount of the transaction is also stored in the transaction database record during step 660. In this manner, the current transaction is anonymously linked to one or more prior transactions associated with the same customer in accordance with the present invention.

A further optional test is performed during step 670 to determine if the customer is entitled to any rewards based on his or her current purchase history. If it is determined during step 670 that the customer is not currently entitled to any rewards, then program control terminates during step 680. If, however, it is determined during step 670 that the customer is entitled to one or more rewards, then the rewards are awarded to the customer at the point of sale during step 690, before program control terminates during step 695.

FIG. 7 is a schematic block diagram of one embodiment of the transaction server 700 of FIG. 1 in further detail incorporating features of the present invention. The transaction server 700 may be embodied as any computing device having a processor 710 and memory 720, such as a personal computer or work station, as would be apparent to a person of ordinary skill in the art. As shown in FIG. 7, the memory 720 of the transaction server 700 includes the transaction records 300, 400, discussed above in conjunction with FIGS. 3 and 4, from a transaction database and the anonymous consumer tracking process 600, discussed above in conjunction with FIG. 6.

In another variation of the invention, elapsed time can be used as a mechanism for associating a validation with a repurchase and therefore the initial transaction is linked to the repurchase transaction through the element of “closeness” in time. For example, if a person buys an e-scratch ticket on Monday, and it has a final outcome value of $14.00 that is played on Wednesday, and the person brings the ticket back to the retailer on Friday, the retailer can validate the ticket and repurchase more outcomes with the $14.00. In this manner, the Monday transaction and the Friday transaction are linked.

### Unique Loyalty Codes

Another aspect of the invention provides a system for broad-based loyalty and promotional functionality. Among other benefits, the disclosed anonymous loyalty tracking system provides anonymous capabilities to allow simple and comfortable corporate loyalty without compromising personal information of a user. Further, the disclosed anonymous loyalty tracking system enables tracking of customer transactions without gathering personal data on individual consumers, as it is recognized, for example, that this can be problematic in a youth-centric industry. In contrast, the disclosed anonymous loyalty tracking system focuses on encouraging consumers to participate and join without revealing personal information, until additional information gathering is required/appropriate (if ever).

In one exemplary implementation, the disclosed anonymous loyalty tracking system utilizes a “unique loyalty code” (ULC) that can be associated with every provided product (real or virtual). The ULC may comprise, for example, a store identifier, product identifier, and timestamp to uniquely identify each individual instance of a product. These ULCs are created by a specialized algorithm that can generate a sufficient number of unique codes that can be specifically associated with a product, brand, SKU, price, or other product characteristic. These ULC codes can be created based on demand by the various brand and product managers. Thus, when not included in the product strategy, the ULCs do not burden the product with lead time, cost, or implementation issues. The ULC codes can be designated with a variety of characteristics, such as promotional or coupon value, instant winners, or entries into assorted contests and on-line communities.

The ULC's are produced in electronic form by an algorithm through a browser interface and can be provided electronically to local printers at point of manufacture to minimize cost and schedule impact. The printed codes are incorporated with product packaging as slip sheets or stickers. For virtual goods, the codes can be, for example, part of the download delivery mechanism or provided in an email to the purchasers.

Upon purchase, consumers utilize the ULC to enter/record their purchase in a corporate (domestic, international, all brands) wide web page. The URL for registering the ULC can optionally be provided with the ULC. Consumers are allowed to identify their account in a number of ways. For example, users can identify their account using one or more of a unique username that they create; entry of a ULC and an email address.

A unique design aspect of this loyalty program is that it does not require all three of the above identification methods (in particular, email address is not required). This approach allows minors to create and maintain their account without divulging any personal information. The new consumer goes to a designated website (the URL would be provided on the same media as the ULC allowing brands to designate specialized views, if desired) to register and enter the ULC. At the website, the consumer is not presented with the typical registration page requiring the entry of personal information (such as email and date-of-birth) but only requesting a unique username, a password and the entry of the ULC. By utilizing a username and ULC (both representing non-personal information while being wholly unique) the user remains anonymous but has, for example, two methods to identify his or her account to the web site. If only a single identification method is used (such as the ULC), then if the consumer loses all traces of previous ULCs he or she will have lost access to the account. Therefore, having the consumer select and enter a secondary unique identifier that they are making up, they are more likely to remember it and be able to log back in if they lose all of their ULCs.

Consumers can add ULCs to their profile at any time and the service provider (e.g., a manufacturer or retailer, or a third party acting on behalf of a manufacturer or retailer) has the ability to communicate directly back to the consumer by posting messages on the consumer's account page. If a consumer forgets their password or username, the ULC can be used to as an entry into their account (since it is unique across the entire population of products). Rather than requiring the user to enter an email address to which the password would be sent, the user enters their username and any of their previously entered ULCs. This technique allows users to quickly establish their accounts without concerns or issues related to minors, or personal privacy.

As consumers build their ULC profile, the service provider can track the products that the consumer is purchasing, provide promotions, information, or product notifications. The service provider gains essentially all of the benefits of traditional web registration processes with the exception of that personal information which causes issues with privacy advocates.

As consumers accumulate ULCs in their profiles, the codes can represent discounts, on-line subscriptions, or other elements in an on-line marketing plan. Since ULCs are uniquely tied to each product and also unique throughout the service provider, consumers can not trade codes between themselves nor enter them multiple times. Codes and products can be marketed and advertized with bonus values on packaging and advertising campaigns. All ULC characteristics are dynamic and server based so that the characteristics can be time, or campaign based if desired.

Consumers can utilize accumulated ULC “points” for purchases, coupons, or other actions. Some of these actions may require additional information (such as mailing addresses, email addresses, or credit card information). This information can be gathered at the time of these events. Other uses of the “points” may be allowed without any additional data gathering (access to restricted on-line activities or games). Use of “points” would be debited against the user's account as appropriate.

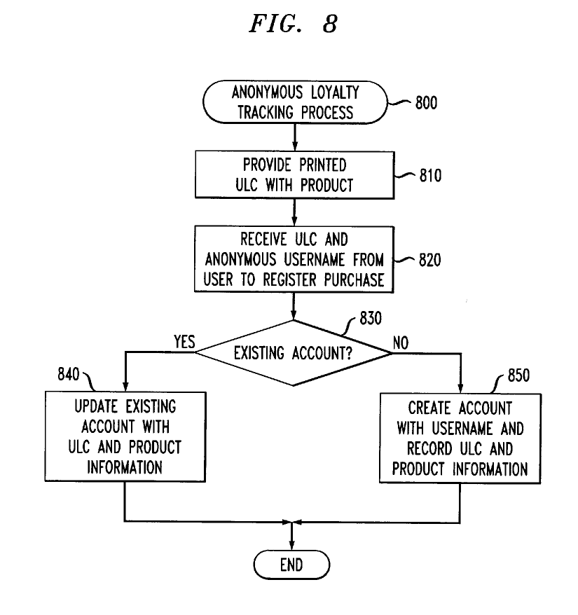

FIG. 8 is a flow chart describing an exemplary implementation of an anonymous loyalty tracking process 800 incorporating features of the present invention. As shown in FIG. 8, the exemplary anonymous loyalty tracking process 800 initially provides a printed or virtual ULC with the sale of a product during step 810. As noted above, the printed codes can be incorporated with product packaging as slip sheets or on stickers, for example, affixed to physical products. For virtual goods, the codes can be, for example, part of the download delivery mechanism or provided in an email to the purchasers.

During step 820, the anonymous loyalty tracking process 800 receives a ULC and an anonymous username from the user to register a purchase. A password may also be required. In one variation, the user may enter only the ULC provided with the purchase, and the system can provide a unique anonymous username (or account number) to the user.

A test is performed during step 830 to determine if the presented username is associated with an existing account. If it is determined during step 830 that the presented username is associated with an existing account, then the existing account is updated during step 840 with the presented ULC and product information. In this manner, the present invention allows the current purchase to be linked to prior purchases through the ULCs and username.

If, however, it is determined during step 830 that the presented username is not associated with an existing account, then an account is created during step 850 with the presented username, ULC and product information. In this manner, the present invention allows an instant account to be created without any personal information. Program control then terminates.

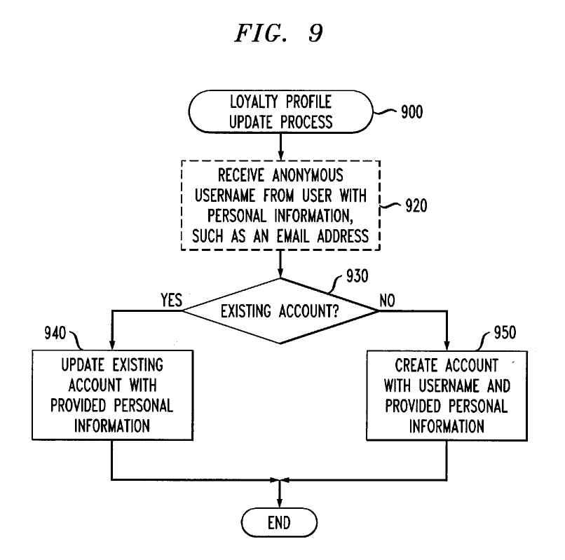

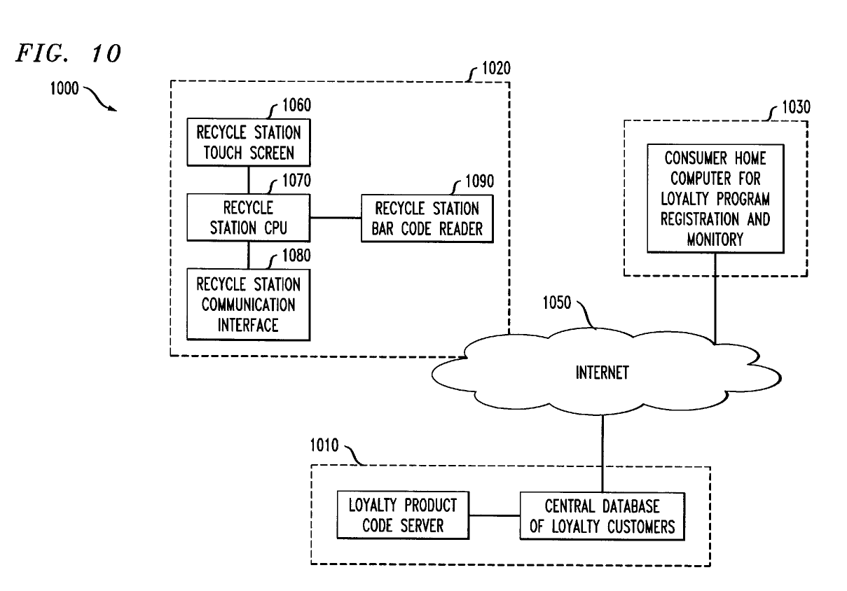

FIG. 9 is a flow chart describing an exemplary implementation of a loyalty profile update process 900 incorporating features of the present invention. It is noted that the provision of the personal information from the user that is processed by the loyalty profile update process 900 is at the discretion of the user. As shown in FIG. 9, the exemplary loyalty profile update process 900 initially, and at the discretion of the user, now receives personal information from the user during step 920, such as an email address, with the anonymous username. A password may also be required.

A test is performed during step 930 to determine if the presented username is associated with an existing account. If it is determined during step 930 that the presented username is associated with an existing account, then the existing account is updated during step 940 with the presented personal information.

If, however, it is determined during step 930 that the presented username is not associated with an existing account, then an account is created during step 950 with the presented username and personal information. Program control then terminates.

### Recycling Using ULCs

Another aspect of the invention encourages user participation in a recycling program through the use of ULCs. The ULCs associated with the recycled product may or may not have been initially registered at the time of purchase. The disclosed anonymous loyalty tracking system encourages recycling and participation by combining the recycling program with a loyalty program incorporating aspects of the present invention.

As previously indicated, consumers buy products that have special loyalty codes (ULC) contained within the packaging or otherwise associated with the product. These codes may be affixed to the outside of the package, for example, if they are protected from compromise by being enclosed in a sealed packet.

Consumers utilize the codes to establish themselves as loyalty participants, for example, by registering the ULC using the anonymous loyalty tracking process 800 of FIG. 8. This process 800 is performed via the Internet allowing the consumer to register as either fully registered users or as anonymous users until they decide to transition to a fully registered user (using the loyalty profile update process 900 of FIG. 9). This registration process encourages the consumers to identify themselves and become known members of the customer base.

The disclosed loyal recycler program allows registered users to simply and quickly perform the recycling process by providing a method for users to identify themselves to the recycling station (using their loyalty program ID (i.e., username) or one of their registered ULC bar codes). This process is performed in real time using a standard bar code reader or by entering the loyalty program ID number on a touch screen or keyboard. By using the registered user method 900, the recycle program is limited to those valued customers that have taken the time and effort to become members of the community. Alternatively, the recycle process can generate a ULC in real-time (or pull one from an already generated list) and provide it to the consumer that is recycling a product and this creates an “account” for the consumer performing the recycle. The consumer can then perform other purchases or recycles and like them. The recycle process then becomes like any other “transaction” that the consumer participates in anonymously until they decide to volunteer additional information.

FIG. 10 is a schematic block diagram of a loyal recycling system 1000 in which the present invention can operate. As shown in FIG. 10, the loyal recycling system 1000 comprises the anonymous loyalty tracking system 1010, recycler station 1020 and a user home station 1030, each connected over the Internet 1050. Generally, the loyal recycling system 1000 implements the process 800 of FIG. 8, and optionally the process 900 of FIG. 9 to enroll and update user accounts with ULC information.

As shown in FIG. 10, the recycler station 1020 comprises a central process unit (CPU) 1070, a screen 1060 (preferably touch screen), a bar code reader 1090 and a communication interface 1080 (such as an Ethernet interface to a local area network (LAN) or an interface to an available wireless technology (such as cellular and/or WiFi). Additionally, the recycler station 1020 may comprise one or more of an image capture device (if an image of the recycled product is desired), a scale (to measure the weight of the recycled product), RFID or magnetic card stripe readers, printers, and other peripherals that may be added to improve the recycling and loyalty process.

The user home station 1030 allows the end users to register and monitor their ULC accounts by connecting to the anonymous loyalty tracking system 1010 over the Internet 1050.

The recycler station 1000 may also support brand, product, SKU, or barcode lookup of recycled products via the touch screen or using the available peripherals, if it is desirable.

As consumers bring products to the recycle station 1000 for recycling, they earn loyalty points that signify their participation as a recycler, allowing them to earn rewards or discounts for the purchase of new products and also provides information about their product profiles (based on a recycling profile developed as they recycle products).

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation, such as the computer system 700 of FIG. 7. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). Suitable interconnections, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor coupled directly or indirectly to memory elements through a system bus. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards, displays, pointing devices, and the like) can be coupled to the system either directly (such as via bus) or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods. apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for monitoring a user, said method comprising the steps of:
providing a unique loyalty code with a sale of a product, wherein said unique loyalty code uniquely identifies each individual instance of said product;
receiving said unique loyalty code from said user as part of a product registration process, wherein said product registration process does not require personal information of said user; and
recording said unique loyalty code in an account anonymously associated with said user.

2. The method of claim 1, further comprising the step of associating said unique loyalty code with one or more prior transactions of said user.

3. The method of claim 1, wherein said recording step records said unique loyalty code in an existing account of said user, wherein said existing account is identified using an account identifier that is not linked to said personal information of said user.

4. The method of claim 1, wherein said providing step further comprises the step of providing said unique loyalty code as part of packaging associated with said product.

5. The method of claim 1, wherein said providing step further comprises the step of providing said unique loyalty code electronically to said user.

6. The method of claim 1, further comprising the step of updating said account with personal information.

7. The method of claim 1, further comprising the step of determining if said user is eligible for a loyalty reward.

8. The method of claim 1, wherein said receiving step occurs at a time of recycling said product.

9. A method for recycling a product, said method comprising the steps of:
providing a unique loyalty code for said product, wherein said unique loyalty code uniquely identifies each individual instance of said product;
receiving said unique loyalty code from said user as part of a recycling registration process, wherein said recycling registration process does not require personal information of said user; and
recording said unique loyalty code in an account anonymously associated with said user.

10. The method of claim 9, further comprising the step of associating said unique loyalty code with one or more prior transactions of said user.

11. The method of claim 9, wherein said recording step records said unique loyalty code in an existing account of said user, wherein said existing account is identified using an account identifier that is not linked to said personal information of said user.

12. The method of claim 9, wherein said providing step further comprises the step of providing said unique loyalty code as part of packaging associated with said product.

13. The method of claim 9, wherein said providing step further comprises the step of providing said unique loyalty code electronically to said user.

14. The method of claim 9, further comprising the step of updating said account with personal information.

15. The method of claim 9, further comprising the step of determining if said user is eligible for a loyalty reward.

16. A system for monitoring a user, said system comprising:
a memory; and
at least one processor, coupled to the memory, operative to:
provide a unique loyalty code with a sale of a product, wherein said unique loyalty code uniquely identifies each individual instance of said product;
receive said unique loyalty code from said user as part of a product registration process, wherein said product registration process does not require personal information of said user; and
record said unique loyalty code in an account anonymously associated with said user.

17. The system of claim 16, wherein said processor is further configured to associate said unique loyalty code with one or more prior transactions of said user.

18. The system of claim 16, wherein said unique loyalty code is recorded in an existing account of said user, wherein said existing account is identified using an account identifier that is not linked to said personal information of said user.

19. The system of claim 16, wherein said unique loyalty code is provided as part of packaging associated with said product.

20. The system of claim 16, wherein said unique loyalty code is provided electronically to said user.

21. The system of claim 16, wherein said processor is further configured to update said account with personal information.

22. The system of claim 16, wherein said processor is further configured to determine if said user is eligible for a loyalty reward.

23. The system of claim 16, wherein said unique loyalty code is received at a time of recycling said product.

24. A system for recycling a product, said system comprising the steps of:
a memory; and
at least one processor, coupled to the memory, operative to:
provide a unique loyalty code for said product, wherein said unique loyalty code uniquely identifies each individual instance of said product;
receive said unique loyalty code from said user as part of a recycling registration process, wherein said recycling registration process does not require personal information of said user; and
record said unique loyalty code in an account anonymously associated with said user.

25. The system of claim 24, wherein said processor is further configured to associate said unique loyalty code with one or more prior transactions of said user.

26. The system of claim 24, wherein said unique loyalty code is recorded in an existing account of said user, wherein said existing account is identified using an account identifier that is not linked to said personal information of said user.

27. The system of claim 24, wherein said processor is further configured to provide said unique loyalty code as part of packaging associated with said product.

28. The system of claim 24, wherein said processor is further configured to provide said unique loyalty code electronically to said user.

29. The system of claim 24, wherein said processor is further configured to update said account with personal information.

30. The system of claim 24, wherein said processor is further configured to determine if said user is eligible for a loyalty reward.
